(19) United States
(12) Patent Application Publication
(10) Pub. No.: US 2009/0079589 A1
(43) Pub. Date: Mar. 26, 2009

(54) Parking guidance apparatus and method

(76) Inventor: Ashok Khubani, Boonton, NJ (US)

Correspondence Address: COOPER & DUNHAM, LLP, 30 Rockefeller Plaza, 20th Floor, NEW YORK, NY, 10112, US

(21) Appl. No.: 11/903,419

(22) Filed: Sep. 21, 2007

(51) Int. Cl. B60Q 1/48

(52) U.S. Cl. 340/932.2

(57) ABSTRACT

A parking guidance system having an anchor for suspending a marking object and an applicator which allows the use of an extension arm or pole to install the system without a ladder. The anchor is connected to a garage ceiling with an adhesive and the filament is connected to the marking object by movable hook. Also, a cleaning attachment is provided to prepare the ceiling for the adhesive.

### BACKGROUND OF THE INVENTION

1. Field of the Invention

This invention generally relates to a method and apparatus for assisting a driver in parking a vehicle in a precise location.

2. Description of the Related Art

Numerous products have been adapted to provide guidance to drivers for parking their vehicles in a precise location. Such devices are useful when, for example, a driver parks a vehicle inside of a garage. Generally, when parking a vehicle inside of a garage, the driver must pull the vehicle sufficiently far enough into the garage so that the rear of the car will not be hit by the garage door when closed, but without pulling in so far that the front of the car hits the garage wall or items stored near the wall. Additionally, a user desirably wishes to leave as much space as possible in front of the car, for example to provide a passageway around the parked car.

One device commonly used in garages to guide a driver into an optimal parking position is a marking object, such as a tennis ball, suspended from a predetermined location on the ceiling of the garage by a filament, such as string. The filament length is selected so that the marking object hangs a selected distance from the ground. The length of the filament and location of the marking object are selected so that a portion of the vehicle, such as the windshield, will contact the ball when the vehicle is in the desired parking location.

In one such device, one end of a string is attached to a ball while the other end is tied to a structure on the ceiling such as a rafter. However, this arrangement is insufficient because a rafter may not be located in a position which coincides with the preferred location of the ball for a particular vehicle and garage. In other such devices, the string can be attached to a nail or screw which is affixed to the garage ceiling. However, this arrangement requires a user to permanently puncture the ceiling and can be difficult to implement depending on the condition and material of the ceiling. Further, to affix the nail or screw likely requires the user to use a ladder. In addition, since one end of the string is tied to the nail or screw and the other end of the string is often taped or stapled to the tennis ball, adjustment of the ball height can be cumbersome.

Accordingly, a parking guidance product and procedure which provides for easy affixation of the filament to any location on the ceiling without requiring a ladder, which does not require penetration of the ceiling, and in which the height of the marking object can be easily and quickly adjusted is needed.

### SUMMARY OF THE INVENTION

One object of the present invention is to provide simplified method for parking a car in a precise location.

Another object of the present invention is to provide a parking guidance kit that can be easily installed at any location of a ceiling without requiring special tools or ladders.

An additional object is to provide such an apparatus that can be affixed to the ceiling without puncturing the ceiling.

Yet another object of the present invention is to provide a way to easily adjust the vertical height of the marking object of the parking guidance system.

To these and other ends, the present invention broadly contemplates the provision of an adjustable parking guidance system including a mount, for example a ceiling anchor connected to a ceiling: (1) solely with an adhesive; (2) solely by another fastener, such as a screw; or (3) with both an adhesive and another fastener, and an applicator for both preparing the ceiling and installing the ceiling anchor. The applicator is designed with a first connector for removable connection to one end of a pole, such as a broom or mop handle, and a second connector for removable connection: (1) to a cleaning attachment for preparing a portion of a ceiling to receive the ceiling anchor; and (2) to the ceiling anchor for affixing the ceiling anchor to the prepared portion of the ceiling. The ceiling anchor is connected to a filament, the free end of which can be connected to the marking object at a desired height such that a vehicle will be in the desired parking position when the marking object touches a pre-selected portion of the vehicle. In one embodiment, the marking object is a soft ball with a catch for the filament.

### BRIEF DESCRIPTION OF THE DRAWINGS

FIG. 1 is a perspective view of the parking guidance apparatus as deployed in a garage according to one embodiment of the present invention;

FIG. 2 is an exploded perspective view of an applicator of a parking guidance apparatus according to one embodiment of the present invention;

FIG. 3 is an exploded perspective view of a cleaning attachment according to one embodiment of the present invention;

FIG. 4 is a exploded perspective view of the ceiling anchor according to one embodiment of the present invention;

FIG. 5 is a sectional view of the ceiling anchor and the marking object according to one embodiment of the present invention; and

FIG. 6 is a perspective view illustrating the application of the ceiling anchor to a garage ceiling using the applicator according to one embodiment of the present invention.

### DETAILED DESCRIPTION OF THE PREFERRED EMBODIMENT

The detailed description set forth below and the accompanying drawings is a description of one embodiment of the invention and is not intended to depict the only manner in which the invention can be constructed.

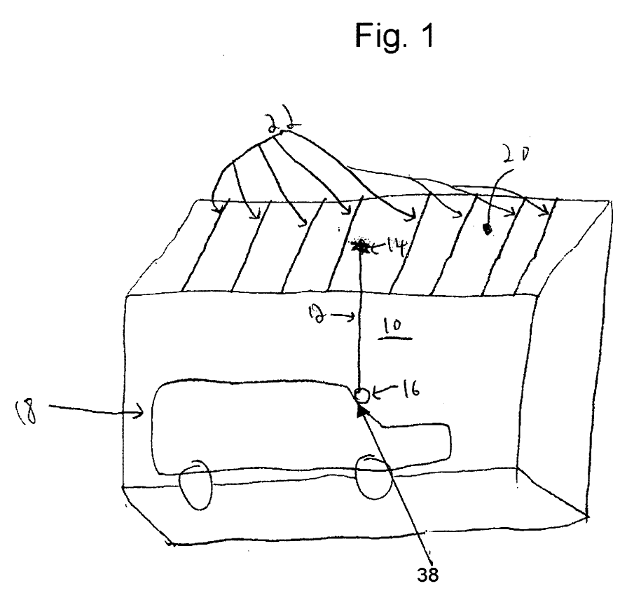

As shown in FIG. 1, the parking guidance device 10 includes a filament 12 which is connected to a ceiling anchor 14 at one end and is connected to a marking object 16 at the other end. The filament 12 can be string, metal wire, plastic line such as fishing line, or any other suitably strong yet flexible product which can support the marking object 16. In one embodiment, filament 12 is a conventional fishing line. The marking object 16 can be any object which is heavy enough to keep the filament 12 plumb and also is sufficiently soft and non-abrasive so as not to damage a vehicle 18. In one embodiment, the outer surface of the marking object 16 is similar to that of a tennis ball.

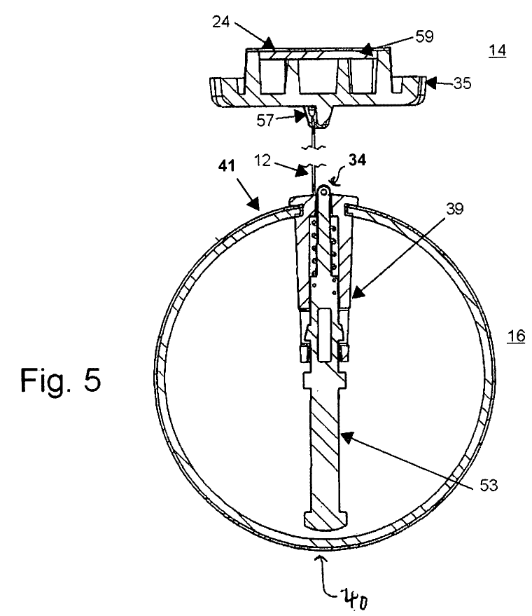

As shown in FIGS. 4 and 5, according to one embodiment of the present invention and unlike a conventional parking guidance device, the filament 12 is connected to a ceiling anchor 14 which is itself connected to the ceiling by an adhesive 24. In one embodiment, the filament 12 is tied to an eyelet 57 formed on the ceiling anchor 14, and the adhesive 24 is affixed to a platform 59 on the ceiling anchor. This arrangement is advantageous at least because the adhesive 24 does not puncture the ceiling 20 as would a screw or a nail, and also because a user can affix the ceiling anchor 14 to any location on the ceiling 20, and not just to a rafter 22.

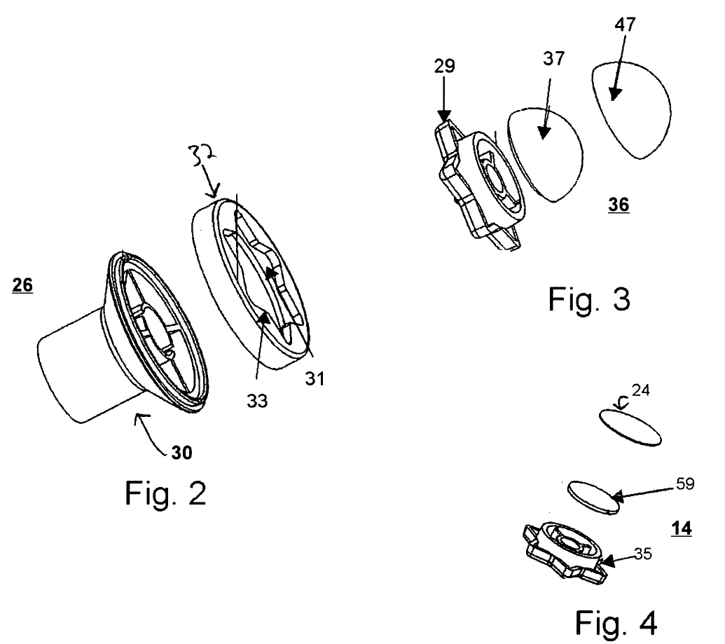

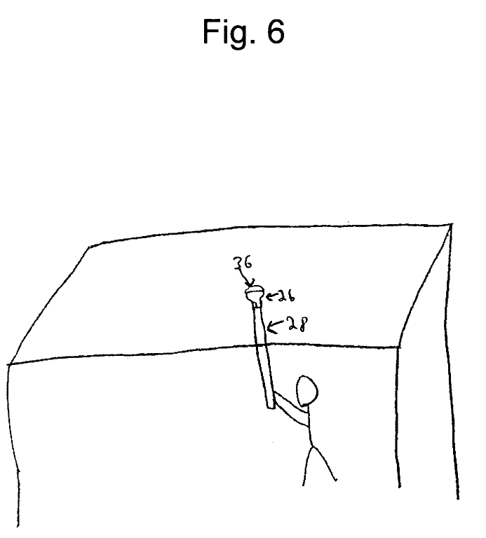

Because garage ceilings 20 typically are too high for a user to reach without the aid of a ladder, as shown in FIGS. 2 and 6, one embodiment of the present invention provides the user with an applicator 26 which removable attaches to an extension arm 28 to aid in the affixing of the ceiling anchor 14 to the ceiling 20. The applicator 26 includes a first connector 30 for removable connection to an extension arm 28 and a second connector 32 for removable attachment to the ceiling anchor 14. In one embodiment, the first connector 30 is internally threaded for mating engagement with a threaded portion of an extension arm 28 such as found on a conventional broom or mop pole or handle.

Other types of first connectors 30 are contemplated by the present invention, for example, the first connector 30 can be a tapered hollowed cavity which can pushed over an end of extension arm 28 until friction holds the extension arm 28 in the cavity. Such a first connector 30 allows the applicator portion 26 to be attached to the extension arm 28 even if the extension arm 28 lacks mating threads which is particularly useful if the other end of the extension arm 28 is permanently attached to a mop or broom head.

The second connector 32 of the applicator 26 is designed for releasable engagement with an attachment portion 35 of the ceiling anchor 14. As shown in FIG. 2, in one embodiment, the second connector 32 has a cavity 31 with an opening 33 in the shape of a six-pointed star for receiving the corresponding attachment portion 35, that is the six-pointed star, of the ceiling anchor 14. In one embodiment, the cavity 31 permits the attachment portion 35 of the ceiling anchor 14 to rotate such that the star becomes temporarily locked in the cavity, that is, the star points of the ceiling anchor 14 are blocked by the triangular indentations of the opening 33. The present invention contemplates the employment of other shapes and/or means to temporarily lock the ceiling anchor 14 in or to the second connector 32.

Accordingly, with the applicator 26, a user can connect the first connector 30 of applicator 26 to an extension arm 28 and then releasably connect the ceiling anchor 14, to which filament 12 is already attached, to the second connector 32. Once connected in this manner, the user can hold the extension arm 28 to push the adhesive 24 located on the ceiling anchor 14 against the ceiling 20. Once the adhesive 24 forms a sufficiently strong bond between ceiling anchor 14 and the ceiling 20, the user may then disconnect (unlock) the ceiling anchor from the second connector 32 of the applicator 26 such that the ceiling anchor remains connected to ceiling 20. For example, in the six-sided star embodiment discussed above, the user need only rotate the applicator 26 by turning the extension handle 28 until the points of the attachment portion 35 can be pulled out of the cavity 31 and through the opening 33. In this manner, the user can position parking guidance device 10 at any location on the ceiling 20 without the use of a ladder.

Before affixing the ceiling anchor 14 to the ceiling 20, in one embodiment of the invention, the ceiling 20 can be cleaned or be otherwise prepared for the receiving the adhesive 24 of the ceiling anchor 14. Such preparation allows for the formation of a stronger bond between the ceiling anchor 14 and the ceiling 20. To this end, in one embodiment of this parking guidance system, a cleaning attachment 36 is provided. This cleaning attachment 36 is designed to carry a cleanser (not shown) to the attachment area on the ceiling 20. In one embodiment, the cleaning attachment 36 includes a sponge 47 or other material formed on a hemispherical surface 37 for holding the cleanser such that pressing the cleaning attachment 36 against the ceiling 20 allows the cleanser to be released and worked or ‘scrubbed’ onto the attachment area on the ceiling 20.

As with the ceiling anchor 14, so that the user can reach the ceiling 20 without the use of a ladder, the cleaning attachment 36 can be connected to the second connector 32 of the applicator 26, and thus, the extension arm 28, with an attachment portion 29 of the same or similar design as the attachment portion 35 of the ceiling anchor. For example, as shown in FIG. 3, the cleaning attachment 36 includes a six-sided star 29 for engaging the second connector 32.

In an alternative embodiment (not shown), the ceiling anchor 14 can be ‘borrowed’ by the hemispherical surface 37 and the sponge 47 by temporarily attaching to the attachment portion 35 of the ceiling anchor for cleaning and then by being removed so that the adhesive 24 of the ceiling anchor 14 can attach to the ceiling.

After ceiling anchor 14 is affixed to the ceiling 20, the marking object 16 can be attached to the filament 12 at the desired height. As shown in FIG. 5, in one embodiment, the filament 12 is a fishing line and the marking object 16 is a ball. This ball includes a spring-loaded mechanism 39 which causes a hook 34 to extend out of the top of the marking object 16. The user can extend the hook 34 by: (1) pushing on a bottom portion 40 of the marking object 16 thereby pushing out the trigger pin 53 which is attached to the hook; and/or (2) pressing on a top portion 41 of the marking object to cause the spring-loaded mechanism 39 to move toward the bottom portion where, as the spring-loaded mechanism presses against the bottom portion, the trigger pin is pushed in the opposite direction causing the hook to be pushed out. The filament 12 can then be inserted under the hook 34 so that when the bottom portion 40 of marking object 16 is released, the spring-loaded mechanism 39 pulls the hook 34 back down into the marking object pulling the filament 12 against or through the surface of the marking object thereby connecting the filament 12 to the marking object 16.

The height of marking object 16 can be easily adjusted by re-extending the hook 34 and moving the marking object 16 to a different position along the filament 12 before allowing the spring-loaded mechanism 39 to pull the hook 34 back into the marking object 16. The spring-loaded mechanism 39 operates in the manner of fishing bobbers.

The position of the ceiling anchor 14 on the ceiling 20 and the height of marking object 16 should be set such that marking object 16 contacts a vehicle 18 at a contact location 38 when the vehicle 18 is in the desired parking location. In one embodiment, the contact location 38 is the windshield of vehicle 18. Once the position guidance device 10 is affixed to the ceiling 20 at the proper location and the marking object 16 has been set to the proper height, a driver can use the parking guidance device 10 to park a vehicle in a precise location by driving the vehicle 18 forward until the position marker 16 contacts the vehicle at the contact location 38. By using this apparatus and method, the vehicle driver can easily park the car in the same precise location and will be provided with visual feedback from marking object 16 to know that the vehicle is in the desired parking location.

While the present application discloses specific embodiments of a parking guidance system, it should be understood that many variations are possible. The present application is intended to extend to all such variations permissible under the claims appended hereto.

What is claimed is:

1. A parking guidance system comprising:
an anchor connected to a surface from which a marking object can be suspended;
a filament connected to the anchor;
the marking object connected to the filament;
an extension arm; and
an applicator having a first connector for removable attachment to the extension arm and a second connector for removable connection to the anchor.

2. The parking guidance system of claim 1 wherein the anchor comprises:
an adhesive portion; and
an attachment portion.

3. The parking guidance system of claim 1 further comprising:
a cleaning attachment for removable connection to the applicator.

4. The parking guidance system of claim 2 wherein the cleaning attachment further comprises a hemispherical base and a cleanser holder.

5. The parking guidance system of claim 2 wherein the attachment portion comprises a six-pointed star.

6. The parking guidance system of claim 2 wherein the adhesive portion comprises double-stick tape.

7. The parking guidance system of claim 1 wherein the marking object further comprises:
a mechanism for extending and retracting a hook from within the marking object.

8. The parking guidance system of claim 7 wherein the mechanism is spring-loaded.

9. The parking guidance system of claim 7 wherein the filament is selected from the group consisting of: string, fishing line, or wire.

10. A method of installing a parking guidance device comprising the steps of:
connecting an extension arm to a first connector on an applicator;
connecting an anchor, to which a filament is attached, to a second connector on the applicator;
affixing the anchor to a surface by manipulating the extension arm;
disconnecting the anchor from the applicator; and
attaching a marking object to the filament at a desired position on the filament.

11. The method of claim 10, further comprising the steps of:
connecting a cleaning attachment to a second connector on the applicator,
applying a cleanser to the cleaning attachment,
brushing a portion of a surface with the cleaning attachment; and
disconnecting the cleaning attachment from the applicator.

12. The method of claim 10, wherein the step of connecting the anchor further comprising the steps of:
inserting a portion of the anchor into the second connector of the applicator; and
rotating the applicator with respect to the anchor.

13. The method of claim 10, wherein the step of disconnecting the anchor further comprising the steps of:
rotating the applicator with respect to the anchor; and
removing a portion of the anchor through an opening in the second connector of the applicator.
